(19) United States
(12) Patent Application Publication
(10) Pub. No.: US 2022/0376376 A1
(43) Pub. Date: Nov. 24, 2022

(54) ELECTRONIC DEVICE COMPRISING ANTENNA MODULE

(71) Applicant: SAMSUNG ELECTRONICS CO., LTD., Suwon-si (KR)

(72) Inventor: Seunggil JEON, Suwon-si (KR)

(21) Appl. No.: 17/879,135

(22) Filed: Aug. 2, 2022

Related U.S. Application Data
(63) Continuation of application No. PCT/KR2021/000447, filed on Jan. 13, 2021.

(30) Foreign Application Priority Data
Feb. 3, 2020 (KR) 10-2020-0012724

(51) Int. Cl. H01Q 1/02; H01Q 1/24; H01Q 9/04

(52) U.S. Cl. CPC H01Q 1/02; H01Q 1/243; H01Q 9/0407

(57) ABSTRACT

An embodiment of the present disclosure discloses an electronic device comprising: at least one processor; an antenna module including at least one antenna operatively connected to the at least one processor; and a first heat radiation member comprising a thermally conductive material arranged on an upper part of the antenna module. The antenna module comprises: a printed circuit board comprising a plurality of layers; a plurality of antennas arranged on at least some of the plurality of layers toward the first heat radiation member to transmit and/or receive signals; and a radio frequency integrated circuit (RFIC) disposed on a lower part of a first layer of the plurality of layers and electrically connected to the at least one processor. The first heat radiation member is arranged on an upper part of a second layer arranged on an upper part of the first layer, and comprises a conductive pattern arranged in an area thereof to be aligned with at least a portion of an edge area of each of the plurality of antennas.

### CROSS-REFERENCE TO RELATED APPLICATIONS

This application is a continuation of International Application No. PCT/KR2021/000447 designating the United States, filed on Jan. 13, 2021 in the Korean Intellectual Property Receiving Office and claiming priority to Korean Patent Application No. 10-2020-0012724, filed on Feb. 3, 2020, in the Korean Intellectual Property Office, the disclosures of which are incorporated by reference herein in their entireties.

### BACKGROUND

### Field

The disclosure relates to an electronic device including an antenna module.

### Description of Related Art

A wireless communication protocol has been proposed for more efficiently transmitting and receiving information resources involved in the operation of an electronic device. For example, a recent electronic device is employing a so-called 5G network communication technology, which is a next-generation network communication technology that uses a signal of a very high frequency band. The 5G network communication is a wireless communication protocol defined by a third-generation partnership project (3GPP), and enables high-speed or large-capacity data transmission/reception using a millimeter wave (mm wave) band signal.

An antenna module supporting the 5G network communication of the electronic device can include a plurality of antenna elements arranged in an array structure. Also, the antenna module can further include a conductive via hole-based wall (or slot) formed to surround each of the plurality of antenna elements, in relation to isolation improvement for the plurality of antenna elements.

As a spaced interval between a plurality of antenna elements is narrowed due to the miniaturization of an antenna module, walls surrounding respective antenna elements may share at least a portion of each other, or may be electrically coupled to each other. In this case, currents can be excited in a plurality of walls at operation of the antenna module, thereby affecting signal characteristics of the antenna module. For example, by the currents excited in the plurality of walls, signals of arbitrary frequency bands can be radiated from the plurality of walls, and this signal radiation can distort a beam generated by the antenna module, or decrease a sensitivity of the beam for a specific direction, thereby inhibiting the formation of a uniform beam coverage of the antenna module.

### SUMMARY

Embodiments of the disclosure may provide an electronic device including an antenna module, for supporting smooth 5G network communication operation of an electronic device, by suppressing a distortion or a sensitivity degradation of a beam provided by the antenna module, based on a conductive pattern implemented in the antenna module.

An electronic device according to an example embodiment may include: at least one processor, an antenna module including at least one antenna operatively connected to the at least one processor, and a first heat radiation member comprising a heat radiating material arranged on an upper part of the antenna module. The antenna module may include: a printed circuit board including a plurality of layers, a plurality of antennas arranged on at least some of the plurality of layers toward the first heat radiation member and configured to transmit and/or receive signals, and a radio frequency integrated circuit (RFIC) arranged on a lower part of a first layer of the plurality of layers and electrically connected to the at least one processor. The first heat radiation member may be disposed on an upper part of a second layer arranged on an upper part of the first layer, and may include a conductive pattern arranged in one region thereof to be aligned with at least a portion of an edge region of each of the plurality of antennas.

An electronic device according to an example embodiment may include: at least one processor, and an antenna module comprising at least one antenna operatively connected to the at least one processor. The antenna module may include: a printed circuit board including a plurality of layers, a plurality of antennas arranged on a first layer of the plurality of layers, a conductive pattern arranged on a second layer arranged on an upper part of the first layer, and a radio frequency integrated circuit (RFIC) arranged on a lower part of a third layer arranged on a lower part of the first layer, and electrically connected to the at least one processor. The conductive pattern may be arranged on the second layer to be aligned with at least a portion of an edge region of each of the plurality of antennas.

According to various example embodiments, an efficiency of 5G network communication of an electronic device may be improved, by eliminating/reducing an electrical factor capable of deteriorating signal characteristics of an antenna module, based on a conductive pattern implemented in the antenna module.

According to various example embodiments, heat radiation of the antenna module may be supported based on the conductive pattern.

In addition, various effects directly or indirectly identified through the present disclosure may be provided.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an electronic device including an antenna module according to various embodiments;

FIG. 2 is an exploded perspective view illustrating an antenna module according to various embodiments;

FIG. 3 is a cross-sectional view of one direction of an antenna module according to various embodiments;

FIG. 4A is a diagram illustrating an effect of improving a signal radiation pattern of each of a plurality of antenna elements according to various embodiments;

FIG. 4B is a diagram illustrating an effect of improving a radiation pattern of a composite beam provided by an antenna module according to various embodiments;

FIG. 5A is an exploded perspective view illustrating an antenna module according to various embodiments

FIG. 5B is a graph illustrating an effect of improving a signal gain of an antenna module according to various embodiments;

FIG. 6A is a diagram illustrating a display of an electronic device according to various embodiments;

FIG. 6B is a diagram illustrating an antenna module according to various embodiments;

FIG. 6C is a graph illustrating an effect of improving a signal gain of an antenna module according to various embodiments;

FIG. 7 is a diagram illustrating an example electronic device in a network environment according to various embodiments; and

FIG. 8 is a block diagram illustrating an example configuration of an electronic device supporting legacy network communication and 5G network communication according to various embodiments.

In relation to a description of the drawings, the same reference numerals may be assigned to the same or corresponding components.

### DETAILED DESCRIPTION

Hereinafter, various example embodiments of the present disclosure are described in greater detail with reference to the accompanying drawings. However, the present disclosure is not intended to be limited by the various embodiments of the present disclosure to a specific embodiment and it is intended that the present disclosure covers all modifications, equivalents, and/or alternatives of the present disclosure provided they come within the scope of the appended claims and their equivalents.

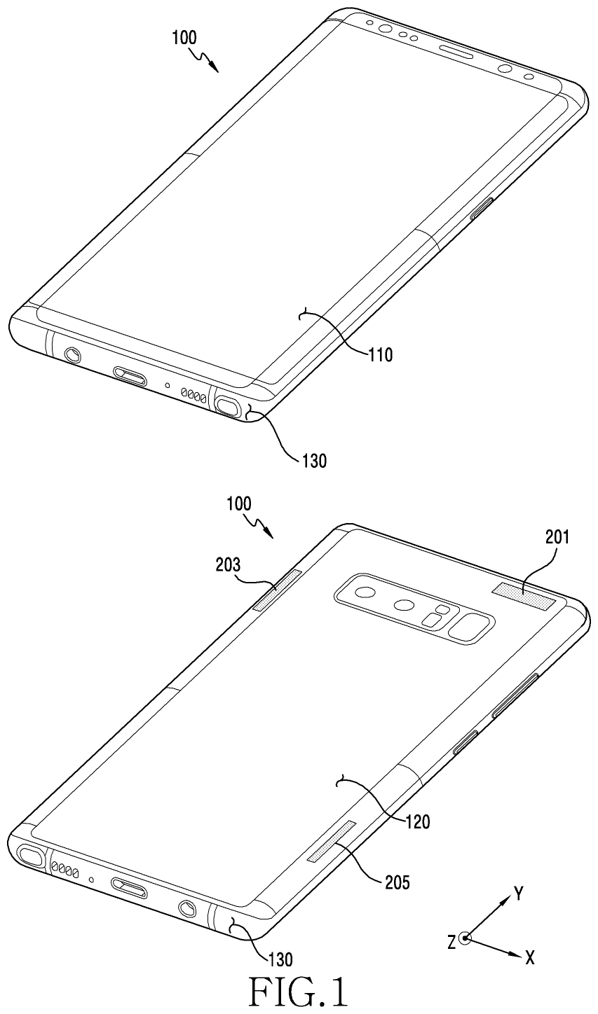

FIG. 1 is a diagram illustrating an electronic device including an antenna module according to various embodiments.

Referring to FIG. 1, the electronic device 100 of an embodiment may include a housing that forms at least a portion of a body or appearance of the electronic device 100. The housing includes, for example, a first plate 110 (e.g., a front plate or cover glass) facing a first direction (e.g., a +Z-axis direction with respect to the illustrated coordinate axis), a second plate 120 (e.g., a rear plate) facing a second direction (e.g., a -Z-axis direction with respect to the illustrated coordinate axis) opposite to the first direction, and a side member 130 arranged in at least a portion of an edge region between the first plate 110 and the second plate 120 (or at least partially surrounding a space between the first plate 110 and the second plate 120).

In an embodiment, the first plate 110, the second plate 120, and the side member 130 may be coupled to each other in at least one region and form the housing of the electronic device 100. In this regard, at least a portion of an edge region of the first plate 110 may be curved at a specified curvature and be extended in the second direction, and correspondingly, an edge region of the second plate 120 may be at least partially curved at the same or similar curvature to the specified curvature and be extended in the first direction. In various embodiments, the side member 130 may be integrally formed with the second plate 120. In this case, the housing of the electronic device 100 may be formed by a combination of the first plate 110 and the second plate 120 that includes the side member 130.

According to an embodiment, an internal space of the electronic device 100 may be defined by the housing, and at least one component related to a functional operation of the electronic device 100 may be accommodated in the internal space. For example, at least one antenna module 201, 203, and/or 205 supporting 5G network communication (e.g., communication using a mm wave band signal of 20 GHz or more) may be arranged in the internal space of the electronic device 100. In an embodiment, when looking at the electronic device 100 from which the second plate 120 is removed, the at least one antenna module 201, 203, and/or 205 may include at least one of the first antenna module 201 arranged adjacent to an upper right region of the electronic device 100, the second antenna module 203 arranged adjacent to an upper left region, and the third antenna module 205 arranged adjacent to a lower right region.

The first antenna module 201 may include, for example, a plurality of patch antenna elements arranged toward the second plate 120 of the electronic device 100. Using the plurality of patch antenna elements, the first antenna module 201 may provide a beam of a radiation pattern facing a first external direction (e.g., a +Z-axis direction with respect to the illustrated coordinate axis) from the inside of the electronic device 100. Or, the first antenna module 201 may include a plurality of dipole antenna elements and, using the plurality of dipole antenna elements, the first antenna module 201 may provide a beam of a radiation pattern facing a second external direction (e.g., a +Y-axis direction with respect to the illustrated coordinate axis) and a third external direction (e.g., a direction between a +Z axis and a -Z axis on a Y-Z plane with respect to the illustrated coordinate axis) from the inside of the electronic device 100.

The second antenna module 203 may include, for example, a plurality of patch antenna elements arranged toward the left side of the electronic device 100 with respect to a rear surface (or the second plate 120) of the electronic device 100. Using the plurality of patch antenna elements, the second antenna module 203 may provide a beam of a radiation pattern facing a fourth external direction (e.g., a -X-axis direction with respect to the illustrated coordinate axis) from the inside of the electronic device 100. Similarly, the third antenna module 205 may include a plurality of patch antenna elements arranged toward the right side of the electronic device 100 with respect to the rear surface (or the second plate 120) of the electronic device 100. Using the plurality of patch antenna elements, the third antenna module 205 may provide a beam of a radiation pattern facing a fifth external direction (e.g., a +X-axis direction with respect to the illustrated coordinate axis) from the inside of the electronic device 100.

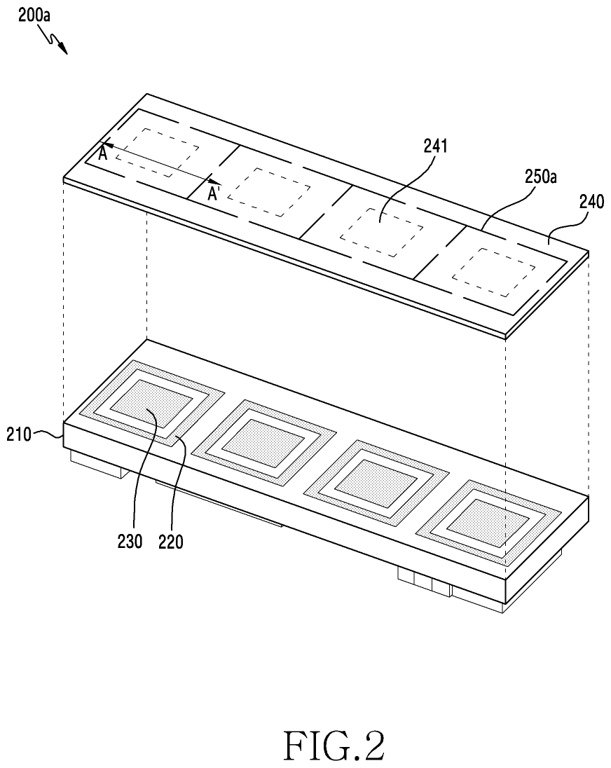

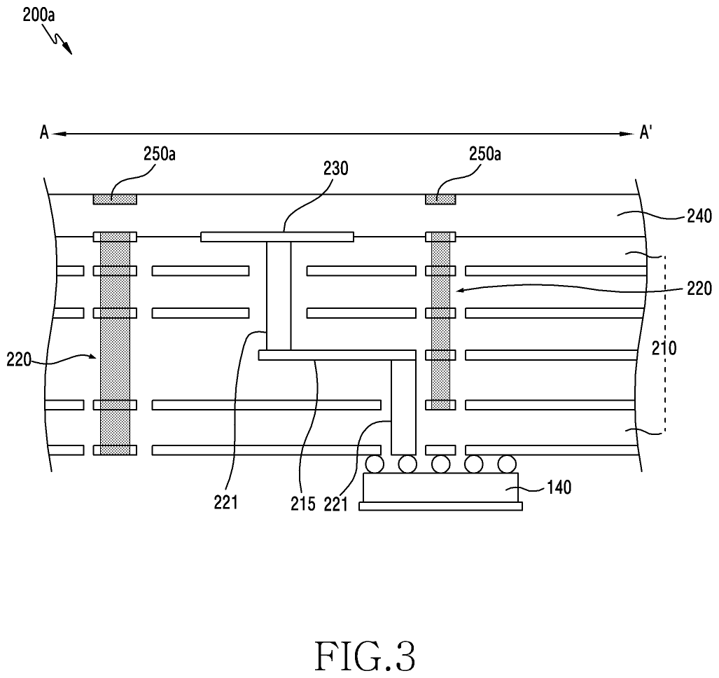

FIG. 2 is an exploded perspective view illustrating an antenna module according to various embodiments, and FIG. 3 is a cross-sectional view of one direction of the antenna module according to various embodiments. In FIG. 3, the one direction for the antenna module may be understood as a direction A-A′ shown in FIG. 2.

Referring to FIG. 2 and FIG. 3, the antenna module 200a (e.g., the first antenna module 201, the second antenna module 203, and/or the third antenna module 205 of FIG. 1) of an embodiment may include a board 210, a plurality of antenna elements 230, and a radio frequency integrated circuit (RFIC) 140. In various embodiments, the antenna module 200a may additionally include at least one other component in addition to the above-described components. For example, the antenna module 200a may further include an absorbing member arranged on a lower part of the RFIC 140, and the absorbing member may block electromagnetic waves emitted toward the inside of an electronic device (e.g., the electronic device 100 of FIG. 1) from the antenna module 200a. According to various embodiments, the absorbing member may include a ferromagnetic material including at least one of iron (Fe), cobalt (Co), nickel (Ni), and a combination of the above materials. Or, the antenna module 200a may further include a shielding member for electromagnetically shielding the RFIC 140. According to various embodiments, the shielding member may include a shield can for accommodating at least a portion of the RFIC 140.

A board 210 (e.g., a printed circuit board or a flexible printed circuit board) may include, for example, a plurality of layers that include a plurality of conductive layers and a plurality of insulating layers. In an embodiment, the plurality of conductive layers and the plurality of insulating layers may be formed to have the same or similar area to each other, and may be laminated alternately and aligned in parallel. In this regard, the board 210 may include a plurality of conductive via holes 220 for electrically connecting the plurality of conductive layers spaced apart by the plurality of insulating layers to each other. According to various embodiments, the plurality of conductive via holes 220 may be formed in the form of passing through the board 210, and may be extended wherein at least some thereof are protruded with respect to a first layer (e.g., the uppermost layer) of the plurality of layers included in the board 210. According to various embodiments, the portion of the plurality of conductive via holes 220 protruded with respect to the first layer may have a shape of a wall (or a slot) surrounding at least a portion of an upper surface of the first layer.

A plurality of antenna elements 230 may be arranged on the first layer. For example, each of the plurality of antenna elements 230 may be arranged on a surface of the first layer, or be arranged inside the first layer. Also, each of the plurality of antenna elements 230 may be arranged in an array structure having a mutually specified spaced interval on the first layer, wherein at least a portion thereof is surrounded by the wall formed by the plurality of conductive via holes 220 protruded with respect to the first layer. In an embodiment, the plurality of antenna elements 230 may include a patch antenna element that provides a beam in front of the antenna module 200a (e.g., in a direction which the first layer faces), and may receive an RF signal from the outside (e.g., an access point or a base station) and forward the RF signal to the RFIC 140, based on the beam provision, or may receive an RF signal for transmission from the RFIC 140 and radiate the RF signal to the outside. In this regard, the board 210 may further include at least one feeding line 215 and at least one conductive via hole 221, that electrically connect each of the plurality of antenna elements 230 and the RFIC 140 and support signal feeding to the plurality of antenna elements 230. According to various embodiments, the at least one feeding line 215 may include at least one of a coaxial cable and a flexible printed circuit board.

The RFIC 140 may be arranged on a lower part of a second layer (e.g., the lowermost layer arranged on a lower part of the first layer) of the plurality of layers included in the board 210, and may process an RF signal that will be received through the plurality of antenna elements 230 or be radiated through the plurality of antenna elements 230. In this regard, the RFIC 140 may change a frequency band of the RF signal that will be received or be radiated. For example, when radiating the RF signal through the plurality of antenna elements 230, the RFIC 140 may convert a baseband signal or an intermediate frequency (IF) signal into an RF signal of a frequency band used for 5G network communication. Or, the RFIC 140 may convert an RF signal received from the outside (e.g., an access point or a base station) into a baseband signal or IF signal which may be processed by the electronic device 100 (or a processor of the electronic device 100).

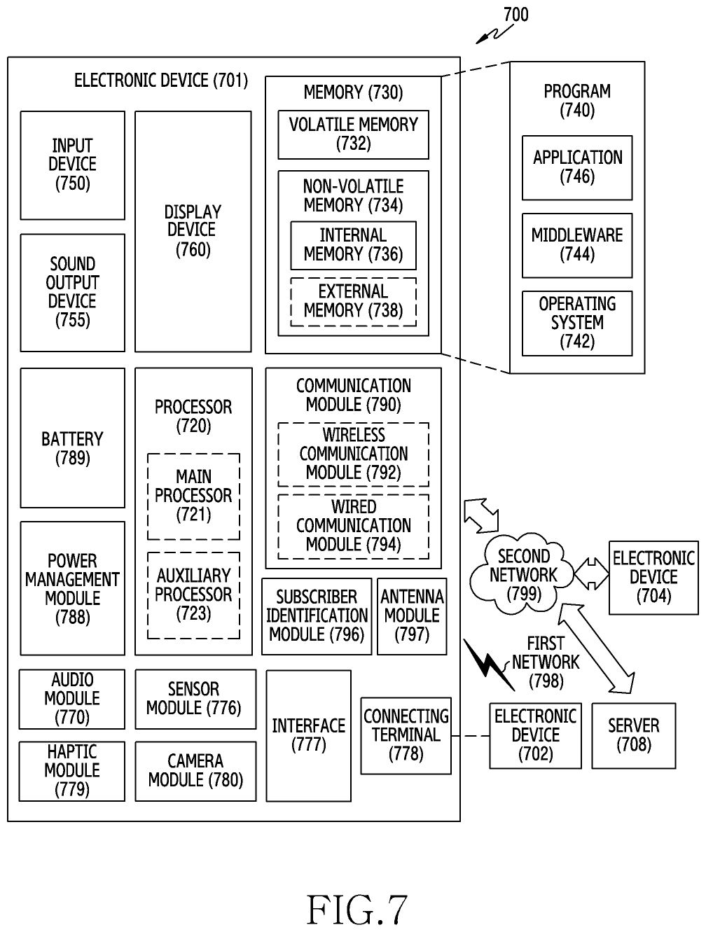

According to an embodiment, the RFIC 140 may be electrically connected to a main processor (e.g., a main processor 721 of FIG. 7) of the electronic device 100, and may operate under the control of the main processor 721. Or, the RFIC 140 may be electrically connected to an auxiliary processor (e.g., a communication processor 723 of FIG. 7) of the electronic device 100 that operates independently of the main processor 721, and may operate under the control of the auxiliary processor 723 regardless of the main processor 721.

In an embodiment, to suppress the deterioration of reception performance or radiation performance of RF signals, the antenna module 200a may further include a substrate 240 on which a conductive pattern 250a is formed. In this regard, when the antenna module 200a is operated, a current may be excited in the wall that is based on the plurality of conductive via holes 220 surrounding each of the plurality of antenna elements 230. In this case, by the excited current, a signal of an arbitrary frequency band may be radiated from the wall and thus, a beam provided through the plurality of antenna elements 230 may be distorted or a sensitivity of a beam for a specific direction may be deteriorated. According to an embodiment, the conductive pattern 250a formed on the substrate 240 may be arranged to be adjacent to the wall, and based on this, the current excited in the wall may be induced to the conductive pattern 250a. The conductive pattern 250a may include, for example, at least one segment region described later, and may block a resonance of the current induced from the wall, based on the at least one segment region, thereby eliminating an electrical factor (e.g., a radiation of a signal of an arbitrary frequency band caused by the current excited in the wall) related to performance deterioration of a beam provided by the antenna module 200a.

The substrate 240 may be formed to have the same or similar area to the board 210, and may be arranged on an upper part of the first layer of the board 210. For example, the substrate 240 may be formed separately from the antenna module 200a and coupled to the first layer, or may be formed integrally with the board 210 to be included as a portion of the antenna module 200a. Or, the substrate 240 may be arranged to be spaced apart from the board 210 by a predetermined interval. For example, the substrate 240 may be coupled to or adhered to a second plate (e.g., the second plate 120 of FIG. 1) of the electronic device 100, and the board 210 may be coupled to or mounted on an internal set structure of the electronic device 100 while maintaining a separation distance from the substrate 240 coupled or adhered to the second plate 120.

According to various embodiments, the substrate 240 may include a non-conductive material having a low permittivity, so as not to impair a function of the conductive pattern 250a or the signal characteristics of a beam provided using the plurality of antenna elements 230. Or, the substrate 240 may at least partially include a conductive material to the extent of not impairing the function of the conductive pattern 250a or the signal characteristics of the beam. For example, the substrate 240 may at least partially include a conductive material in a region (e.g., an outer region of the conductive pattern 250a) not overlapping with the plurality of antenna elements 230, and the conductive material may support the improvement of the heat radiation performance of the antenna module 200a.

In an embodiment, at laminating (e.g., coupling or integrating) between the board 210 and the substrate 240, the conductive pattern 250a may be aligned with an edge region of each of the plurality of antenna elements 230 arranged on the first layer of the board 210. For example, the conductive pattern 250a may at least partially overlap with the wall that is based on the plurality of conductive via holes 220 formed to surround each of the plurality of antenna elements 230, or may be aligned with an outer edge region of the wall. According to various embodiments, the conductive pattern 250a may be formed on a surface of the substrate 240 (e.g., be adhered in the form of a sheet), or may be formed inside the substrate 240.

According to an embodiment, the conductive pattern 250a may support external heat radiation of a heat provided from the antenna module 200a. For example, the conductive pattern 250a may be implemented with a metal material having a high thermal conductivity (e.g., heat radiating/conductive material) and conduct a heat provided from the antenna module 200a to the substrate 240. Based on this, the substrate 240 including the conductive pattern 250a may function as a heat radiation plate (e.g., a first heat radiation member) for the antenna module 200a, and the substrate 240 may be formed to have a relatively large area on the board 210 in relation to an increase of a surface area for the outside as well.

According to an embodiment, the conductive pattern 250a may include at least one segment region for blocking a resonance of a current which is induced from the wall being based on the plurality of conductive via holes 220 to the conductive pattern 250a. For example, the conductive pattern 250a may include at least one segment region implemented at a random position on the conductive pattern 250a. Or, the conductive pattern 250a may include a plurality of segment regions, and for example, a portion of the conductive pattern 250a aligned with an edge region of an arbitrary antenna element may include a plurality of segment regions regularly or symmetrically implemented.

In various embodiments, a portion of the conductive pattern 250a aligned with an edge region of an arbitrary antenna element (e.g., a first antenna element), and a portion of the conductive pattern 250a aligned with an edge region of another antenna element (e.g., a second antenna element) adjacent to the arbitrary antenna element may be at least partially shared. According to various embodiments, one region of the substrate 240 corresponding to the inner side of the conductive pattern 250a may include a plurality of openings 241 (e.g., the first opening) in order to prevent and/or reduce a transmission loss of an RF signal caused by the substrate 240. For example, at laminating (e.g., coupling or integrating) between the board 210 and the substrate 240, one region of the substrate 240 aligned with the plurality of antenna elements 230 may be implemented as the plurality of openings 241.

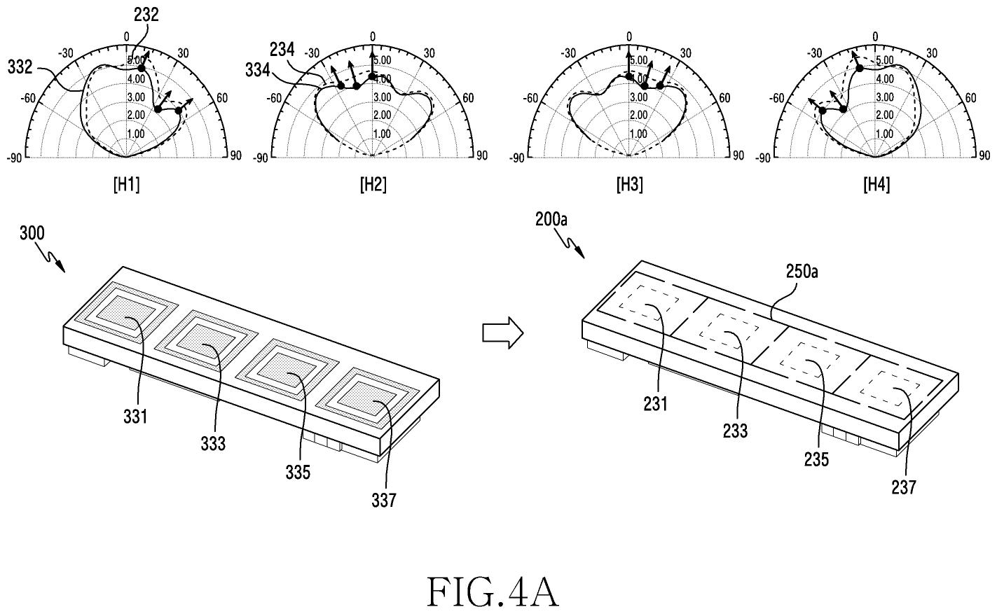

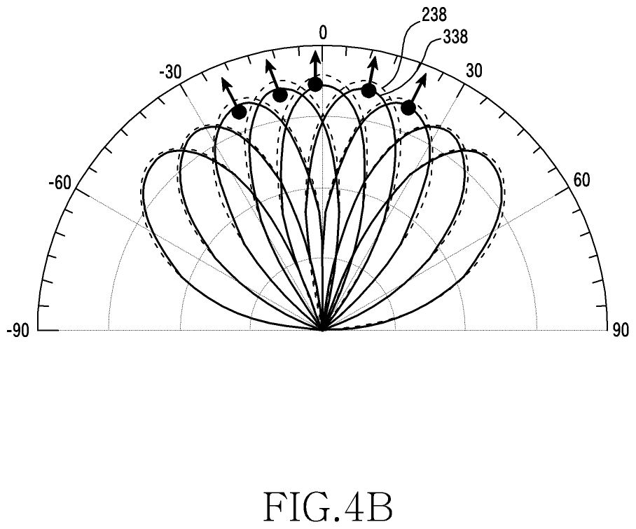

FIG. 4A is a diagram illustrating an effect of improving a signal radiation pattern of each of a plurality of antenna elements according to various embodiments, and FIG. 4B is a diagram illustrating an effect of improving a composite beam radiation pattern provided by an antenna module according to various embodiments.

Referring to FIG. 4A, a signal radiation pattern provided by each of a plurality of antenna elements 231, 233, 235, and 237 may have improved performance, based on the conductive pattern 250a of an embodiment. For example, the conductive pattern 250a may eliminate an electrical factor capable of impairing the signal radiation pattern performance of the plurality of antenna elements 231, 233, 235, and 237, by preventing/reducing a phenomenon in which a current is excited in a wall that is based on a plurality of conductive via holes (e.g., the plurality of conductive via holes 220 of FIG. 2 or FIG. 3), and a phenomenon in which a signal of an arbitrary frequency band is radiated from the wall due to this.

In relation to an experimental example mentioned below, the solid line shown in FIG. 4A and FIG. 4B may indicate a radiation pattern of a comparison target antenna module 300 not including the conductive pattern 250a, and the dotted line may indicate a radiation pattern of the antenna module 200a including the conductive pattern 250a.

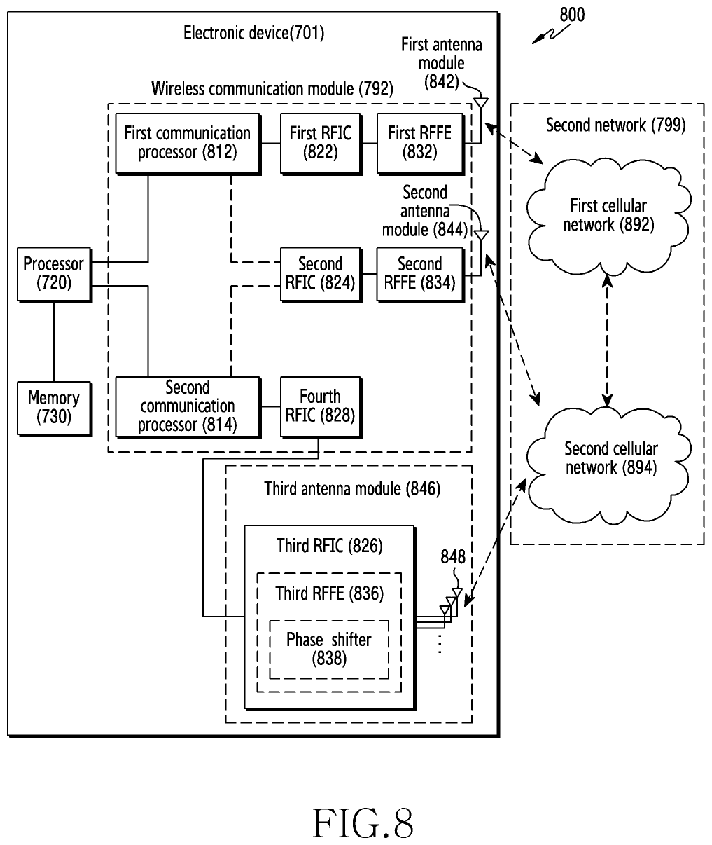

Referring to a first radiation pattern (H1) as an experimental example, it may be checked that a distortion or sensitivity of a radiation pattern 232 provided by a first antenna element 231 of the antenna module 200a of an embodiment has been improved in comparison with a radiation pattern 332 provided by a second antenna element 331 of a comparison target antenna module 300 (e.g., a third antenna module 846 of FIG. 8) not including the conductive pattern 250a.

A second radiation pattern (H4) may indicate a radiation pattern of a third antenna element 237 arranged in a symmetrical position to the first antenna element 231 of the antenna module 200a of an embodiment, and a radiation pattern of a fourth antenna element 337 of the comparison target antenna module 300. Referring to the second radiation pattern (H4), the radiation pattern of the third antenna element 237 may have a symmetrical directivity to the radiation pattern (232 of H1) of the first antenna element 231 described above, and it may be checked that distortion or sensitivity has been improved in comparison with the radiation pattern of the comparison target fourth antenna element 337.

Similarly, referring to a third radiation pattern (H2), it may be checked that a distortion or sensitivity of a radiation pattern 234 provided by a fifth antenna element 233 of the antenna module 200a of an embodiment has been improved in comparison with a radiation pattern 334 provided by a sixth antenna element 333 of the comparison target antenna module 300. Also, as shown in a fourth radiation pattern (H3), a radiation pattern of a seventh antenna element 235 arranged symmetrically to the fifth antenna element 233 may have a symmetrical directivity to the radiation pattern (234 of H2) of the fifth antenna element 233, and it may be checked that distortion or sensitivity has been improved in comparison with a radiation pattern of a comparison target eighth antenna element 335.

As checked from the above-described experimental example, the signal radiation pattern provided by each of the plurality of antenna elements 231, 233, 235, and 237 may have improved performance, based on the conductive pattern 250a of an embodiment, and this may be understood that the beamforming performance of the antenna module 200a has been improved as well. For example, referring to FIG. 4A and FIG. 4B, it may be checked that a composite beam radiation pattern 238 of the antenna module 200a in which the radiation patterns provided from the respective plurality of antenna elements 231, 233, 235, and 237 are synthesized has an improved sensitivity and has a more uniform beam coverage compared to a composite beam radiation pattern 338 of the comparison target antenna module 300 not including the conductive pattern 250a.

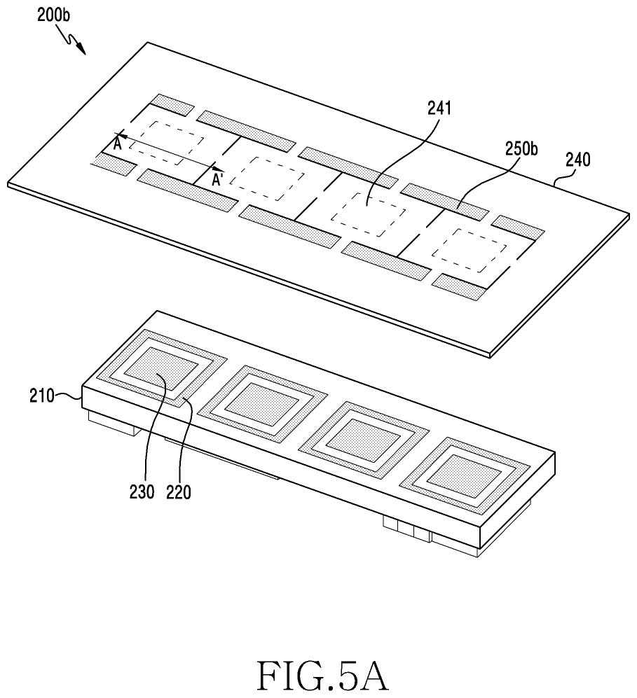

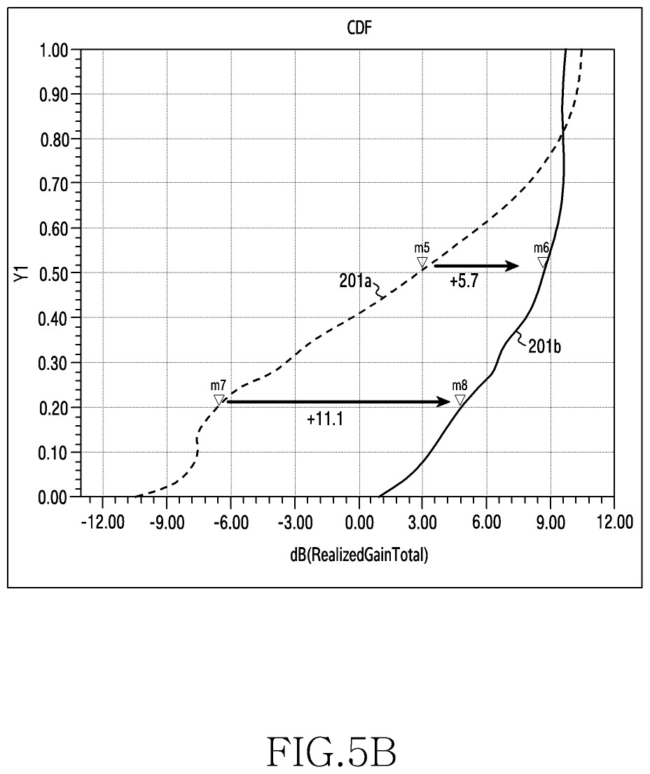

FIG. 5A is an exploded perspective view illustrating an antenna module according to various embodiments, and FIG. 5B is a graph illustrating an effect of improving a signal gain of the antenna module according to various embodiments. In FIG. 5A, the same reference numerals are assigned to the same components as the above-described antenna module, and a duplicate description may be omitted.

Referring to FIG. 5A, a conductive pattern 250b of the antenna module 200b (e.g., the first antenna module 201, the second antenna module 203, and/or the third antenna module 205 of FIG. 1) of an embodiment may improve a width of at least a partial section. For example, in the conductive pattern 250b, a width of a partial section corresponding to a lengthwise direction (e.g., A-A′ direction) of a substrate 240 may be extended by a specified amount toward the outside of the conductive pattern 250b (or toward an edge region of the substrate 240). In one example, when a first section of the conductive pattern 250b not extended in width has a width of a first size, a second section of the conductive pattern 250b extended in width may include a width of a second size relatively larger than the first size.

According to various embodiments, the width of the partial section of the conductive pattern 250b may be also further extended at a size equal to or different from a specified size, toward the inside of the conductive pattern 250b (toward the opening 241), to the extent of not impairing signal characteristics of a beam provided using a plurality of antenna elements 230. Or, a width of all sections of the conductive pattern 250b may be also extended at a size equal to or different from the specified size, toward at least one of the outside and the inside of the conductive pattern 250b, without distinction such as the partial section, to the extent of not impairing the signal characteristics of the beam provided using the plurality of antenna elements 230. According to various embodiments, the substrate 240 may be formed in a relatively large area on the board 210 in order to cover the extension of the width of the conductive pattern 250b or in order to improve heat radiation performance due to an increase of a surface area. When the area of the substrate 240 is extended as above, the heat radiation performance of the antenna module 200b through the substrate 240 may be improved.

According to an embodiment, when a width of at least a partial section of the conductive pattern 250b is extended, the radiation performance of the antenna module 200b may be improved. In this regard, FIG. 5B may show an antenna gain cumulative distribution function (CDF) 201a for a comparison target antenna module (e.g., the antenna module 200a of FIG. 2, FIG. 3, or FIG. 4A) in which a width of a conductive pattern is not extended, and an antenna gain CDF 201b for the antenna module 200b including the conductive pattern 250b of the extended width. Referring to FIG. 5B, it may be checked that, when a width of at least a partial section of the conductive pattern 250b included in the antenna module 200b is extended, performance is improved in terms of antenna gain in comparison with the comparison target antenna module 200a.

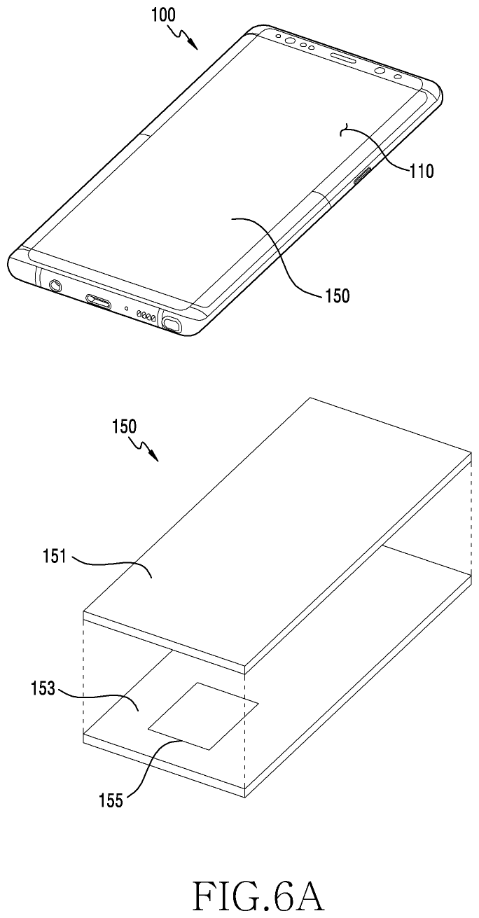

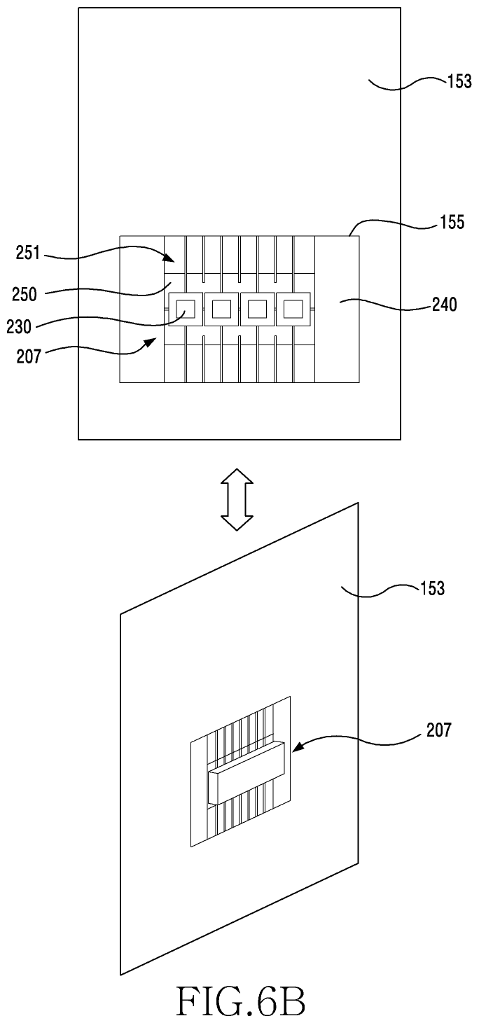

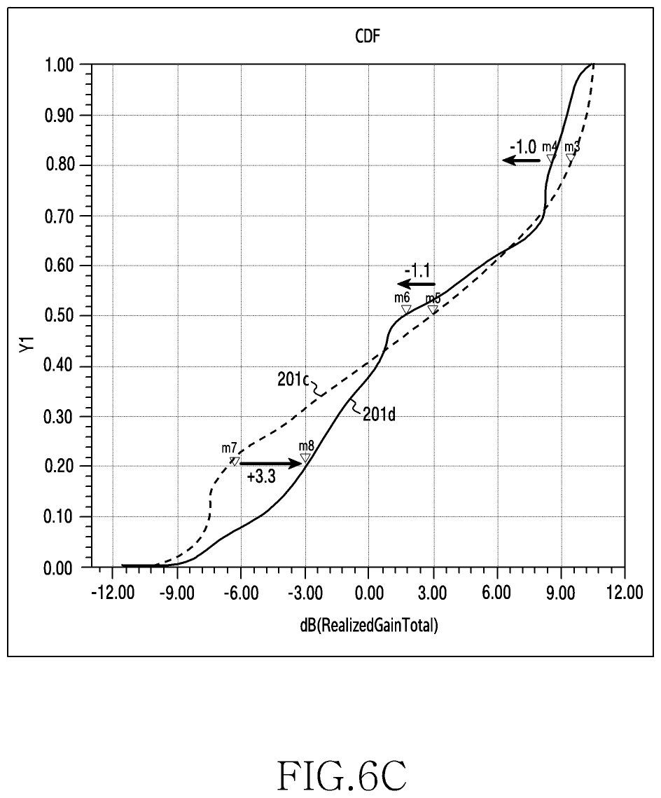

FIG. 6A is a diagram illustrating an example display of an electronic device according to various embodiments, FIG. 6B is a diagram illustrating an antenna module according to various embodiments, and FIG. 6C is a graph illustrating an effect of signal gain improvement of an antenna module according to various embodiments. In FIG. 6B, the same reference numerals are assigned to the same components as the above-described antenna module, and a duplicate description may be omitted.

Referring to FIG. 6A and FIG. 6B, the electronic device 100 of an embodiment may include a display 150 for outputting (or displaying) various contents related to a function or service of the electronic device 100. For example, the display 150 may be arranged wherein at least a portion thereof is visible to the outside through a first plate 110 (e.g., a front plate or cover glass), and may occupy most of a front surface of the electronic device 100.

According to an embodiment, the display 150 may include a display panel 151 and a heat radiation plate 153 (e.g., a second heat radiation member) arranged on a lower part of the display panel 151. The heat radiation plate 153 may, for example, radiate a heat provided from the display 150 to the outside, or conduct the heat to other components (e.g., a set structure supporting the display 150) of the electronic device 100, and in this regard, the heat radiation plate 153 may at least partially include a metal material (e.g., copper (Cu)) having a high thermal conductivity. In various embodiments, the display 150 may further include, in addition to the display panel 151 and the heat radiation plate 153, at least one of a touch panel (or a touch sensor), a pressure panel (or a pressure sensor), and a digitizer. Or, the display 150 may further include the first plate 110 as a partial layer of the display 150 as well.

In an embodiment, the electronic device 100 may further include a fourth antenna module 207 arranged on a lower part of the display 150, in addition to the aforementioned first antenna module (e.g., the first antenna module 201 of FIG. 1), second antenna module (e.g., the second antenna module 203 of FIG. 1), and/or third antenna module (e.g., the third antenna module 205 of FIG. 1). In an embodiment, at least a portion of the fourth antenna module 207 may be embedded in one region of the heat radiation plate 153 included in the display 150. For example, at least a portion of the fourth antenna module 207 may be embedded in an opening 155 (e.g., a second opening) formed in the heat radiation plate 153 and may be coupled to the heat radiation plate 153. In this regard, the opening 155 may be formed to have a size corresponding to a size of the fourth antenna module 207 (e.g., an area of the substrate 240 included in the fourth antenna module 207).

According to an embodiment, when the fourth antenna module 207 is embedded in the opening 155, a plurality of antenna elements 230 included in the fourth antenna module 207 may aim for the display panel 151 arranged on an upper part of the heat radiation plate 153. Also, a substrate 240 included in the fourth antenna module 207 may be arranged in parallel to one surface of the heat radiation plate 153, wherein a step is not formed on one surface of the heat radiation plate 153 facing the display panel 151.

In an embodiment, a width of at least a partial section of the conductive pattern 250 of the fourth antenna module 207 may be extended toward the outside of the conductive pattern 250 (or toward an edge region of the substrate 240), and a size of the extended width may be the same or different depending on the section. According to an embodiment, the conductive pattern 250 may include a heat radiation pattern 251 which is branched from the conductive pattern 250 and is physically connected to the heat radiation plate 153 of the display 150. The heat radiation pattern 251 may include, for example, a metal material having a high thermal conductivity in the same or similar manner to the conductive pattern 250. Based on this, a heat provided from the fourth antenna module 207 may be conducted to the substrate 240 and the heat radiation pattern 251 through the conductive pattern 250, and may be conducted to the heat radiation plate 153 of the display 150 more effectively by the heat radiation pattern 251. According to various embodiments, the heat radiation pattern 251 on the fourth antenna module 207 may be omitted as well.

FIG. 6C may show an antenna gain CDF 201c for a comparison target antenna module (e.g., the first antenna module 201, the second antenna module 203, or the third antenna module 205 of FIG. 1 implemented as the antenna module 200a of FIG. 2, FIG. 3, or FIG. 4A) and an antenna gain CDF 201d for the fourth antenna module 207. Referring to FIG. 6C, it may be checked that an RF signal of the fourth antenna module 207 arranged on a lower part of the display 150 has a similar antenna gain performance in comparison with the comparison target antenna module 201, 203, or 205 arranged in a different position (e.g., an upper right region, an upper left region, or a lower right region of the electronic device).

An electronic device according to various example embodiments may include: at least one processor, an antenna module comprising at least one antenna operatively connected to the at least one processor, and a first heat radiation member comprising a thermally conductive material arranged on an upper part of the antenna module.

According to various example embodiments, the antenna module may include: a printed circuit board including a plurality of layers, a plurality of antennas arranged on at least some of the plurality of layers toward the first heat radiation member and configured to transmit and/or receive signals, and a radio frequency integrated circuit (RFIC) disposed on a lower part of a first layer of the plurality of layers and electrically connected to the at least one processor.

According to various example embodiments, the first heat radiation member may be disposed on an upper part of a second layer arranged on an upper part of the first layer, and may include a conductive pattern arranged in one region thereof to be aligned with at least a portion of an edge region of each of the plurality of antennas.

According to various example embodiments, the antenna module may further include a plurality of conductive via holes passing through the plurality of layers and extending wherein at least some of the conductive via holes protrude with respect to the second layer.

According to various example embodiments, the protruding at least some of the plurality of conductive via holes may form a wall surrounding at least a portion of an edge region of each of the plurality of antennas.

According to various example embodiments, the conductive pattern may be arranged to at least partially overlap with the wall or be aligned with an edge region of the wall.

According to various example embodiments, the conductive pattern may include at least one segment region formed in an arbitrary position on the conductive pattern.

According to various example embodiments, the conductive pattern may include a plurality of segment regions formed in regular or symmetrical positions on the conductive pattern.

According to various example embodiments, the plurality of antennas may include a first patch antenna and a second patch antenna arranged adjacent to the first patch antenna.

According to various example embodiments, a portion of the conductive pattern aligned with at least a portion of an edge region of the first patch antenna and another portion of the conductive pattern aligned with at least a portion of an edge region of the second patch antenna may be at least partially shared.

According to various example embodiments, a partial section of the conductive pattern may include a width having a first size, and a section other than the partial section may include a width having a second size larger than the first size to face an edge region of the first heat radiation member.

According to various example embodiments, the conductive pattern may be arranged in the form of relief or engraving on the first heat radiation member.

According to various example embodiments, the first heat radiation member may further include a plurality of first openings in one region aligned with the plurality of antennas.

According to various example embodiments, the first heat radiation member may include at least a partial non-conductive material having a permittivity less than a specified permittivity.

According to various example embodiments, the first heat radiation member may include the same or wider area than the plurality of layers.

According to various example embodiments, the electronic device may further include a display including a display panel and a second heat radiation member comprising a thermally conductive material arranged to face the display panel and having a second opening formed in one region.

According to various example embodiments, the antenna module may be arranged wherein at least a portion of the antenna module is embedded in the second opening.

According to various example embodiments, the antenna module may be embedded in the second opening, wherein the plurality of antennas face the display panel, and the first heat radiation member is parallel to one surface of the second heat radiation member facing the display panel.

According to various example embodiments, the conductive pattern may include a heat radiation pattern branched from the conductive pattern and connected to the second heat radiation member.

An electronic device according to various example embodiments may include: at least one processor, and an antenna module including at least one antenna operatively connected to the at least one processor.

According to various example embodiments, the antenna module may include a printed circuit board including a plurality of layers, a plurality of antennas arranged on a first layer of the plurality of layers, a conductive pattern arranged on a second layer arranged on an upper part of the first layer, and a radio frequency integrated circuit (RFIC) arranged on a lower part of a third layer arranged on a lower part of the first layer, and electrically connected to the at least one processor.

According to various example embodiments, the conductive pattern may be arranged on the second layer to be aligned with at least a portion of an edge region of each of the plurality of antennas.

According to various example embodiments, the antenna module may further include a plurality of conductive via holes passing through at least some of the plurality of layers and extending wherein at least some of the conductive via holes protrude with respect to the first layer.

According to various example embodiments, the protruding at least some of the plurality of conductive via holes may form a wall surrounding at least a portion of an edge region of each of the plurality of antennas.

According to various example embodiments, the conductive pattern may be arranged to at least partially overlap with the wall or align with an edge region of the wall.

According to various example embodiments, the conductive pattern may include a plurality of segment regions formed in regular or symmetrical positions on the conductive pattern.

According to various example embodiments, a partial section of the conductive pattern may include a width having a first size, and a section other than the partial section may include a width having a second size larger than the first size to face an edge region of the second layer.

According to various example embodiments, the second layer may include a plurality of first openings in one region aligned with the plurality of antennas.

According to various example embodiments, the electronic device may further include a display including a display panel and a heat radiation member comprising a thermally conductive material arranged to face the display panel and having a second opening formed in one region,

According to various example embodiments, the antenna module may be arranged wherein at least a portion of the antenna module is embedded in the second opening.

According to various example embodiments, the conductive pattern may include a heat radiation pattern branched from the conductive pattern and connected to the heat radiation member.

An antenna module according to various example embodiments may include: a plurality of layers, a plurality of patch antenna elements arranged on a first layer of the plurality of layers, a conductive pattern arranged on a second layer arranged on an upper part of the first layer of the plurality of layers, and a radio frequency integrated circuit (RFIC) arranged on a lower part of a third layer arranged on a lower part of the first layer of the plurality of layers.

FIG. 7 is a diagram illustrating an example electronic device in a network environment according to various embodiments.

Referring to FIG. 7, the electronic device 701 in the network environment 700 may communicate with an electronic device 702 via a first network 798 (e.g., a short-range wireless communication network), or an electronic device 704 or a server 708 via a second network 799 (e.g., a long-range wireless communication network). According to an embodiment, the electronic device 701 may communicate with the electronic device 704 via the server 708. According to an embodiment, the electronic device 701 may include a processor 720, memory 730, an input device 750, a sound output device 755, a display device 760, an audio module 770, a sensor module 776, an interface 777, a haptic module 779, a camera module 780, a power management module 788, a battery 789, a communication module 790, a subscriber identification module (SIM) 796, or an antenna module 797. In various embodiments, at least one (e.g., the display device 760 or the camera module 780) of the components may be omitted from the electronic device 701, or one or more other components may be added in the electronic device 701. In various embodiments, some of the components may be implemented as single integrated circuitry. For example, the sensor module 776 (e.g., a fingerprint sensor, an iris sensor, or an illuminance sensor) may be implemented as embedded in the display device 760 (e.g., a display).

The processor 720 may execute, for example, software (e.g., a program 740) to control at least one other component (e.g., a hardware or software component) of the electronic device 701 coupled with the processor 720, and may perform various data processing or computation. According to an embodiment, as at least part of the data processing or computation, the processor 720 may load a command or data received from another component (e.g., the sensor module 776 or the communication module 790) in volatile memory 732, process the command or the data stored in the volatile memory 732, and store resulting data in non-volatile memory 734. According to an embodiment, the processor 720 may include a main processor 721 (e.g., a central processing unit (CPU) or an application processor (AP)), and an auxiliary processor 723 (e.g., a graphics processing unit (GPU), an image signal processor (ISP), a sensor hub processor, or a communication processor (CP)) that is operable independently from, or in conjunction with, the main processor 721. Additionally or alternatively, the auxiliary processor 723 may be adapted to consume less power than the main processor 721, or to be specific to a specified function. The auxiliary processor 723 may be implemented as separate from, or as part of the main processor 721.

The auxiliary processor 723 may control at least some of functions or states related to at least one component (e.g., the display device 760, the sensor module 776, or the communication module 790) among the components of the electronic device 701, instead of the main processor 721 while the main processor 721 is in an inactive (e.g., sleep) state, or together with the main processor 721 while the main processor 721 is in an active state (e.g., executing an application). According to an embodiment, the auxiliary processor 723 (e.g., an image signal processor or a communication processor) may be implemented as part of another component (e.g., the camera module 780 or the communication module 790) functionally related to the auxiliary processor 723.

The memory 730 may store various data used by at least one component (e.g., the processor 720 or the sensor module 776) of the electronic device 701. The various data may include, for example, software (e.g., the program 740) and input data or output data for a command related thereto. The memory 730 may include the volatile memory 732 or the non-volatile memory 734.

The program 740 may be stored in the memory 730 as software, and may include, for example, an operating system (OS) 742, middleware 744, or an application 746.

The input device 750 may receive a command or data to be used by other component (e.g., the processor 720) of the electronic device 701, from the outside (e.g., a user) of the electronic device 701. The input device 750 may include, for example, a microphone, a mouse, a keyboard, or a digital pen (e.g., a stylus pen).

The sound output device 755 may output sound signals to the outside of the electronic device 701. The sound output device 755 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 760 may visually provide information to the outside (e.g., a user) of the electronic device 701. The display device 760 may include, for example, a display, a hologram device, or a projector and control circuitry to control a corresponding one of the display, hologram device, and projector. According to an embodiment, the display device 760 may include touch circuitry adapted to detect a touch, or sensor circuitry (e.g., a pressure sensor) adapted to measure the intensity of force incurred by the touch.

The audio module 770 may convert a sound into an electrical signal and vice versa. According to an embodiment, the audio module 770 may obtain the sound via the input device 750, or output the sound via the sound output device 755 or a headphone of an external electronic device (e.g., an electronic device 702) directly (e.g., wiredly) or wirelessly coupled with the electronic device 701.

The sensor module 776 may detect an operational state (e.g., power or temperature) of the electronic device 701 or an environmental state (e.g., a state of a user) external to the electronic device 701, and then generate an electrical signal or data value corresponding to the detected state. According to an embodiment, the sensor module 776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 777 may support one or more specified protocols to be used for the electronic device 701 to be coupled with the external electronic device (e.g., the electronic device 702) directly (e.g., wiredly) or wirelessly. According to an embodiment, the interface 777 may include, for example, a high definition multimedia interface (HDMI), a universal serial bus (USB) interface, a secure digital (SD) card interface, or an audio interface.

A connecting terminal 778 may include a connector via which the electronic device 701 may be physically connected with the external electronic device (e.g., the electronic device 702). According to an embodiment, the connecting terminal 778 may include, for example, a HDMI connector, a USB connector, a SD card connector, or an audio connector (e.g., a headphone connector).

The haptic module 779 may convert an electrical signal into a mechanical stimulus (e.g., a vibration or a movement) or electrical stimulus which may be recognized by a user via his tactile sensation or kinesthetic sensation. According to an embodiment, the haptic module 779 may include, for example, a motor, a piezoelectric element, or an electric stimulator.

The camera module 780 may capture a still image or moving images. According to an embodiment, the camera module 780 may include one or more lenses, image sensors, image signal processors, or flashes.

The power management module 788 may manage power supplied to the electronic device 701. According to an embodiment, the power management module 788 may be implemented as at least part of, for example, a power management integrated circuit (PMIC).

The battery 789 may supply power to at least one component of the electronic device 701. According to an embodiment, the battery 789 may include, for example, a primary cell which is not rechargeable, a secondary cell which is rechargeable, or a fuel cell.

The communication module 790 may support establishing a direct (e.g., wired) communication channel or a wireless communication channel between the electronic device 701 and the external electronic device (e.g., the electronic device 702, the electronic device 704, or the server 708) and performing communication via the established communication channel. The communication module 790 may include one or more communication processors that are operable independently from the processor 720 (e.g., the application processor (AP)) and supports a direct (e.g., wired) communication or a wireless communication. According to an embodiment, the communication module 790 may include a wireless communication module 792 (e.g., a cellular communication module, a short-range wireless communication module, or a global navigation satellite system (GNSS) communication module) or a wired communication module 794 (e.g., a local area network (LAN) communication module or a power line communication (PLC) module). A corresponding one of these communication modules may communicate with the external electronic device via the first network 798 (e.g., a short-range communication network, such as Bluetooth™, wireless-fidelity (Wi-Fi) direct, or infrared data association (IrDA)) or the second network 799 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 792 may identify and authenticate the electronic device 701 in a communication network, such as the first network 798 or the second network 799, using subscriber information (e.g., international mobile subscriber identity (IMSI)) stored in the subscriber identification module 796.

The antenna module 797 may transmit or receive a signal or power to or from the outside (e.g., the external electronic device) of the electronic device 701. According to an embodiment, the antenna module 797 may include an antenna including a radiating element including a conductive material or a conductive pattern formed in or on a substrate (e.g., PCB). According to an embodiment, the antenna module 797 may include a plurality of antennas. In such a case, at least one antenna appropriate for a communication scheme used in the communication network, such as the first network 798 or the second network 799, may be selected, for example, by the communication module 790 (e.g., the wireless communication module 792) from the plurality of antennas. The signal or the power may then be transmitted or received between the communication module 790 and the external electronic device via the selected at least one antenna. According to an embodiment, another component (e.g., a radio frequency integrated circuit (RFIC)) other than the radiating element may be additionally formed as part of the antenna module 797.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 701 and the external electronic device 704 via the server 708 coupled with the second network 799. Each of the electronic devices 702 and 704 may be a device of a same type as, or a different type, from the electronic device 701. According to an embodiment, all or some of operations to be executed at the electronic device 701 may be executed at one or more of the external electronic devices 702, 704, or 708. For example, if the electronic device 701 should perform a function or a service automatically, or in response to a request from a user or another device, the electronic device 701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 701. The electronic device 701 may provide the outcome, with or without further processing of the outcome, as at least part of a reply to the request. To that end, a cloud computing, distributed computing, or client-server computing technology may be used, for example.

FIG. 8 is a block diagram illustrating an example configuration of an electronic device supporting legacy network communication and 5G network communication according to an embodiment.

Referring to FIG. 8, an electronic device 701 may include a first communication processor (e.g., including processing circuitry) 812, a second communication processor (e.g., including processing circuitry) 814, a first radio frequency integrated circuit (RFIC) 822, a second RFIC 824, a third RFIC 826, a fourth RFIC 828, a first radio frequency front end (RFFE) 832, a second RFFE 834, a first antenna module 842, a second antenna module 844, and an antenna 848. The electronic device 701 may further include a processor (e.g., including processing circuitry) 720 and a memory 730. The second network 799 may include a first cellular network 892 and a second cellular network 894. According to an embodiment, the electronic device may further include at least one of the parts shown in FIG. 7 and the second network 799 may further include at least one another network. According to an embodiment, the first communication processor 812, the second communication processor 814, the first RFIC 822, the second RFIC 824, the fourth RFIC 828, the first RFFE 832, and the second RFFE 834 may form at least a portion of a wireless communication module 792. According to an embodiment, the fourth RFIC 828 may be omitted or may be included as a portion of the third RFIC 826.

The first communication processor 812 may include various processing circuitry and can support establishment of a communication channel with a band to be used for wireless communication with the first cellular network 892 and legacy network communication through the established communication channel. According to various embodiments, the first cellular network may be a legacy network including a 2G, 3G, 4G, or Long-Term Evolution (LTE) network. The second communication processor 814 can support establishment of a communication channel corresponding to a designated band (e.g., about 6 GHz about 60 GHz) of a band to be used for wireless communication with the second cellular network 894 and 5G network communication through the established communication channel. According to various embodiments, the second cellular network 894 may be a 5G network that is defined in 3GPP. Further, according to an embodiment, the first communication processor 812 or the second communication processor 814 may include various processing circuitry and can support establishment of a communication channel corresponding to another designated band (e.g., about 6GHz or less) of a band to be used for wireless communication with the second cellular network 894 and 5G network communication through the established communication channel. According to an embodiment, the first communication processor 812 and the second communication processor 814 may be implemented in a single chip or a single package. According to various embodiments, the first communication processor 812 or the second communication processor 814 may be disposed in a single chip or a single package together with the processor 720, the auxiliary processor 723, or the communication module 790.

The first RFIC 822, in transmission, can converts a baseband signal generated by the first communication processor 812 into a radio frequency (RF) signal of about 700 MHz to about 3 GHz that is used for the first cellular network 892 (e.g., a legacy network). In reception, an RF signal can be obtained from the first cellular network 892 (e.g., a legacy network) through an antenna (e.g., the first antenna module 842) and can be preprocessed through an RFFE (e.g., the first RFFE 832). The first RFIC 822 can covert the preprocessed RF signal into a baseband signal so that the preprocessed RF signal can be processed by the first communication processor 812.

The second RFIC 824 can convert a baseband signal generated by the first communication processor 812 or the second communication processor 814 into an RF signal in a Sub6 band (e.g., about 6 GHz or less) (hereafter, 5G Sub6 RF signal) that is used for the second cellular network 894 (e.g., a 5G network). In reception, a 5G Sub6 RF signal can be obtained from the second cellular network 894 (e.g., a 5G network) through an antenna (e.g., the second antenna module 844) and can be preprocessed through an RFFE (e.g., the second RFFE 834). The second RFIC 824 can convert the processed 5G Sub6RF signal into a baseband signal so that the processed 5G Sub6RF signal can be processed by a corresponding communication processor of the first communication processor 812 or the second communication processor 814.

The third RFIC 826 can convert a baseband signal generated by the second communication processor 814 into an RF signal in a 5G Above6 band (e.g., about 6 GHz˜about 60 GHz) (hereafter, 5G Above6RF signal) that is used for the second cellular network 894 (e.g., a 5G network). In reception, a 5G Above6RF signal can be obtained from the second cellular network 894 (e.g., a 5G network) through an antenna (e.g., the antenna 848) and can be preprocessed through the third RFFE 836. The third RFIC 826 can covert the preprocessed 5G Above6RF signal into a baseband signal so that the preprocessed 5G Above6 RF signal can be processed by the first communication processor 814. According to an embodiment, the third RFFE 836 may be provided as a portion of the third RFIC 826.

The electronic device 701, according to an embodiment, may include a fourth RFIC 828 separately from or as at least a portion of the third RFIC 826. In this case, the fourth RFIC 828 can convert a baseband signal generated by the second communication processor 814 into an RF signal in an intermediate frequency band (e.g., about 9 GHz-about 11 GHz) (hereafter, IF signal), and then transmit the IF signal to the third RFIC 826. The third RFIC 826 can convert the IF signal into a 5G Above6RF signal. In reception, a 5G Above6RF signal can be received from the second cellular network 894 (e.g., a 5G network) through an antenna (e.g., the antenna 848) and can be converted into an IF signal by the third RFIC 826. The fourth RFIC 828 can covert the IF signal into a baseband signal so that IF signal can be processed by the second communication processor 814.

According to an embodiment, the first RFIC 822 and the second RFIC 824 may be implemented as at least a portion of a single chip or a single package. According to an embodiment, the first RFFE 832 and the second RFFE 834 may be implemented as at least a portion of a single chip or a single package. According to an embodiment, at least one of the first antenna module 842 or the second antenna module 844 may be omitted, or may be combined with another antenna module and can process RF signals in a plurality of bands.

According to an embodiment, the third RFIC 826 and the antenna 848 may be disposed on a substrate, thereby being able to form a third antenna module 846. For example, the wireless communication module 792 or the processor 720 may be disposed on a first substrate (e.g., a main PCB). In this case, the third RFIC 826 may be disposed in a partial area (e.g., the bottom) and the antenna 848 may be disposed in another partial area (e.g., the top) of a second substrate (e.g., a sub PCB) that is different from the first substrate, thereby being able to form the third antenna module 846. By disposing the third RFIC 826 and the antenna 848 on the same substrate, it is possible to reduce the length of the transmission line therebetween. Accordingly, it is possible to reduce a loss (e.g., attenuation) of a signal in a high-frequency band (e.g., about 6 GHz˜about 60 GHz), for example, which is used for 5G network communication, due to a transmission line. Accordingly, the electronic device 701 can improve the quality and the speed of communication with the second cellular network 894 (e.g., 5G network).

According to an embodiment, the antenna 848 may be an antenna array including a plurality of antenna elements that can be used for beamforming. In this case, the third RFIC 826, for example, as a portion of the third RFFE 836, may include a plurality of phase shifters 838 corresponding to the antenna elements. In transmission, the phase shifters 838 can convert the phase of a 5G Above6RF signal to be transmitted to the outside of the electronic device 701 (e.g., to a base station of a 5G network) through the respectively corresponding antenna elements. In reception, the phase shifters 838 can convert the phase of a 5G Above6RF signal received from the outside through the respectively corresponding antenna element into the same or substantially the same phase. This enables transmission or reception through beamforming between the electronic device 701 and the outside.

The second cellular network 894 (e.g., a 5G network) may be operated independently from (e.g., Stand-Along (SA)) or connected and operated with (e.g., Non-Stand Alone (NSA)) the first cellular network 892 (e.g., a legacy network). For example, there may be only an access network (e.g., a 5G radio access network (RAN) or a next generation RAN (NG RAN)) and there is no core network (e.g., a next generation core (NGC)) in a 5G network. In this case, the electronic device 701 can access the access network of the 5G network and then can access an external network (e.g., the internet) under control by the core network (e.g., an evolved packed core (EPC)) of the legacy network. Protocol information (e.g., LTE protocol information) for communication with a legacy network or protocol information (e.g., New Radio (NR) protocol information) for communication with a 5G network may be stored in the memory 830 and accessed by another part (e.g., the processor 720, the first communication processor 812, or the second communication processor 814).

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 740) including one or more instructions that are stored in a storage medium (e.g., internal memory 736 or external memory 738) that is readable by a machine (e.g., the electronic device 701). For example, a processor (e.g., the processor 720) of the machine (e.g., the electronic device 701) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
at least one processor;
an antenna module including at least one antenna operatively connected to the at least one processor; and
a first heat radiation member comprising a thermally conductive material arranged on an upper part of the antenna module,
wherein the antenna module comprises:
a printed circuit board comprising a plurality of layers;
a plurality of antennas arranged on at least some of the plurality of layers toward the first heat radiation member to transmit and/or receive signals; and
a radio frequency integrated circuit (RFIC) disposed on a lower part of a first layer of the plurality of layers and electrically connected to the at least one processor, and
wherein the first heat radiation member is arranged on an upper part of a second layer arranged on an upper part of the first layer, and comprises a conductive pattern arranged in one region thereof to be aligned with at least a portion of an edge region of each of the plurality of antennas.

2. The electronic device of claim 1, wherein the antenna module further comprises a plurality of conductive via holes passing through the plurality of layers and extending from the plurality of layers wherein at least some of the conducive via holes protrude with respect to the second layer,
the protruding at least some of the plurality of conductive via holes form a wall surrounding at least a portion of an edge region of each of the plurality of antennas, and
the conductive pattern is arranged to at least partially overlap with the wall or be aligned with an edge region of the wall.

3. The electronic device of claim 1, wherein the conductive pattern comprises a plurality of segment regions formed in regular or symmetrical positions on the conductive pattern.

4. The electronic device of claim 1, wherein the plurality of antennas comprise a first patch antenna and a second patch antenna arranged adjacent to the first patch antenna, and
a portion of the conductive pattern aligned with at least a portion of an edge region of the first patch antenna and another portion of the conductive pattern aligned with at least a portion of an edge region of the second patch antenna are at least partially shared.

5. The electronic device of claim 1, wherein a partial section of the conductive pattern comprises a width having a first size, and a section other than the partial section comprises a width having a second size larger than the first size to face an edge region of the first heat radiation member.

6. The electronic device of claim 1, wherein the first heat radiation member further comprises a plurality of first openings in one region aligned with the plurality of antennas.

7. The electronic device of claim 1, further comprising a display comprising a display panel and a second heat radiation member comprising a thermally conductive material arranged to face the display panel and having a second opening formed in one region,
wherein the antenna module is arranged wherein at least a portion of the antenna module is embedded in the second opening.

8. The electronic device of claim 7, wherein the antenna module is embedded in the second opening, wherein the plurality of antennas face the display panel, and the first heat radiation member is parallel to one surface of the second heat radiation member facing the display panel.

9. The electronic device of claim 7, wherein the conductive pattern comprises a heat radiation pattern branched from the conductive pattern and connected to the second heat radiation member.

10. An electronic device comprising:
at least one processor; and
an antenna module including at least one antenna operatively connected to the at least one processor,
wherein the antenna module comprises:
a printed circuit board comprising a plurality of layers;
a plurality of antennas arranged on a first layer of the plurality of layers;
a conductive pattern arranged on a second layer arranged on an upper part of the first layer; and
a radio frequency integrated circuit (RFIC) disposed on a lower part of a third layer arranged on a lower part of the first layer, and electrically connected to the at least one processor, and
wherein the conductive pattern is arranged on the second layer to be aligned with at least a portion of an edge region of each of the plurality of antennas.

11. The electronic device of claim 10, wherein the antenna module further comprises a plurality of conductive via holes passing through at least some of the plurality of layers and extending from the plurality of layers wherein at least some of the conductive via holes protrude with respect to the first layer,
the protruding at least some of the plurality of conductive via holes form a wall surrounding at least a portion of an edge region of each of the plurality of antennas, and
the conductive pattern is arranged to at least partially overlap with the wall or align with an edge region of the wall.

12. The electronic device of claim 10, wherein a partial section of the conductive pattern comprises a width having a first size, and a section other than the partial section comprises a width having a second size relatively larger than the first size to face an edge region of the second layer.

13. The electronic device of claim 10, wherein the second layer comprises a plurality of first openings in one region aligned with the plurality of antennas.

14. The electronic device of claim 10, further comprising a display comprising a display panel and a heat radiation member comprising a thermally conductive material arranged to face the display panel and having a second opening formed in one region,
wherein the antenna module is arranged wherein at least a portion of the antenna module is embedded in the second opening.

15. The electronic device of claim 14, wherein the conductive pattern comprises a heat radiation pattern branched from the conductive pattern and connected to the heat radiation member.

16. The electronic device of claim 1, wherein the conductive pattern comprises at least one segment region formed in an arbitrary position on the conductive pattern.

17. The electronic device of claim 1, wherein the conductive pattern is arranged in a form of relief or engraving on the first heat radiation member.

18. The electronic device of claim 1, wherein the first heat radiation member comprises at least a partial non-conductive material having a permittivity less than a specified permittivity.

19. The electronic device of claim 1, wherein the first heat radiation member comprises an area same to or wider than the plurality of layers.

20. The electronic device of claim 10, wherein the conductive pattern comprises a plurality of segment regions formed in regular or symmetrical positions on the conductive pattern.
